(19) United States
(12) Patent Application Publication
(10) Pub. No.: US 2020/0011036 A1
(43) Pub. Date: Jan. 9, 2020

(54) SANITARY INSERT UNIT

(71) Applicant: Neoperl GmbH, Mullehim (DE)

(72) Inventors: David Birmelin, Mullheim (DE); Georg Stadtler, Mullheim (DE)

(73) Assignee: Neoperl GmbH, Mullheim (DE)

(21) Appl. No.: 16/490,360

(22) PCT Filed: Dec. 18, 2017
(86) PCT No.: PCT/EP2017/083220

§ 371 Date: Aug. 30, 2019

(30) Foreign Application Priority Data
Mar. 13, 2017 (DE) 20 2017 101 435.5

(51) Int. Cl. E03C 1/084; B05B 1/30

(52) U.S. Cl. CPC E03C 1/084; B05B 1/3046

(57) ABSTRACT

A sanitary insert unit (116) including a functional unit which provides a throughflow opening (8) and has an adjustment element (9), which adjustment element (9) is arranged so as to be movable or adjustable axially into the throughflow opening (8) and out of the throughflow opening (8), the adjustment element (9) being in driving connection with an actuating element (10), which (10) is arranged on the outflow side of the throughflow opening (8) and is actuable from the outside. The insert unit (116) further includes a sliding guide (11) having at least one run-on bevel (12) is arranged in the driving connection between the actuating element (10) and the adjustment element (9), with the sliding guide converting a rotational movement of the actuating element (10) into an axial adjustment movement of the adjustment element (9).

### BACKGROUND

The invention relates to a sanitary insert unit comprising a functional unit which provides a throughflow opening and has an adjustment element, which adjustment element is arranged so as to be movable or adjustable axially into the throughflow opening and out of the throughflow opening, the adjustment element being in driving connection with an actuating element, which is arranged on the outflow side of the throughflow opening and is actuable from the outside.

A sanitary insert unit of the type mentioned at the beginning which can be inserted into the water outlet of a sanitary outlet fitting is already known from EP 2 536 886 B1. In order to be able to change the throughflow cross section of the insert unit and/or the volumetric flow of the water flowing through, the previously known insert unit has a functional unit which provides a throughflow opening, wherein an adjustment element is arranged so as to be adjustable axially into the throughflow opening and out of the throughflow opening. By axial adjustment of the adjustment element, which is actuable on an outflow side of the throughflow opening, the clear throughflow cross section of the throughflow opening can be changed. In an exemplary embodiment shown in FIGS. 28 to 34 of EP 2 536 886 B1, the adjustment element is guided in an axially displaceable, but rotationally fixed manner in the housing interior. On its outflow-side end surface, the adjustment element has a threaded opening in which an actuating element which can be handled from the outside has an internal thread engaging, which actuating element is supported at its end facing away from the adjustment element on the outlet end side of the previously known insert unit, said outlet end side being formed from a honeycomb structure. By unscrewing of the actuating element from the threaded opening in the adjustment element, the adjustment element is displaced counter to the throughflow direction in the housing interior of the previously known insert unit and the clear throughflow cross section can be correspondingly changed. However, by the unscrewing of adjustment element and actuating element, there is the risk of the housing parts of the housing which are latched releasably to one another will also be pressed apart and that the previously known functional unit will fall apart.

### SUMMARY

It is therefore the object to provide a sanitary insert unit of the type mentioned at the beginning which is distinguished by high functional reliability.

This object is achieved according to the invention in the case of the insert unit of the type mentioned at the beginning in particular in that a sliding guide having at least one run-on bevel is arranged in the driving connection between the actuating element and the adjustment element, said sliding guide converting a rotational movement of the actuating element into an axial adjustment movement of the adjustment element.

The insert unit according to the invention contains a functional unit which provides a throughflow opening for the water flowing through the insert unit. An adjustment element is provided here which is arranged so as to be movable or adjustable axially into the throughflow opening, to increase a flow resistance formed by the throughflow opening, and also out of the throughflow opening, to reduce said flow resistance. The adjustment element of the functional unit providing the throughflow opening is in driving connection with an actuating element which is arranged on the outflow side of the throughflow opening and is actuable from the outside. A sliding guide having at least one run-on bevel is arranged in the driving connection between the actuating element and the adjustment element, said sliding guide converting a rotational movement of the actuating element into an axial adjustment movement of the actuating element. The insert unit according to the invention is distinguished by high functional reliability. Here, with the aid of the insert unit according to the invention, by adjustment of the actuating element, which is actuable from the outside, the quantity of water flowing through the insert unit according to the invention can be limited or adjusted independently of the pressure to an adjustable maximum value.

In a preferred embodiment according to the invention, the sliding guide formed between the adjustment element and the actuating element defines a closed guide track, and therefore the adjustment element returns into its starting position at the latest after a full revolution on the actuating element, in particular after a half revolution. In this embodiment, handling errors are reliably avoided because the adjustment element always returns into its starting position after a full revolution. The actuating element can be moved here both in the one direction of rotation and in the other direction of rotation without malfunctions of the insert unit according to the invention thereby being triggered. Since operating errors are excluded in this embodiment, the functional reliability of the insert unit according to the invention is additionally also promoted.

Operating errors can also be excluded by the fact that the sliding guide is designed to be stop-free. In the case of such a stop-free sliding guide, it is possible to rotate the actuating element beyond 360°, wherein the adjustment element returns into its starting position at the latest after a full revolution on the actuating element.

A precisely metered adjustment of the insert unit according to the invention is promoted if the sliding guide is designed to be step-free or jump-free.

So that the set water volume cannot be unintentionally adjusted during the operation of the insert unit according to the invention, it is advantageous if a gradient of the run-on bevel is dimensioned in such a manner that the sliding guide is self-locking.

In a structurally simple and therefore also preferred embodiment according to the invention, the run-on bevel forms a section of a preferably encircling guide track.

In order to prevent an unintentional adjustment of the relative position taken up between the actuating element and the adjustment element, in an exemplary embodiment according to the invention a latching mechanism, in particular having at least one ball catch, is formed, with which the actuating element and/or the adjustment element can be fixed in different angular positions. In a preferred development according to the invention, part of the latching mechanism is formed on the sliding guide in this case.

It may be advantageous if the adjustment element is mounted rotatably and in particular in an axially rotationally displaceable manner on the or a housing part or insert part.

By contrast, in another development according to the invention, the adjustment element is guided in a rotationally fixed but axially displaceable manner on the or a housing part or insert part.

It is also possible that the adjustment element is in driving connection with the actuating element in a rotationally fixed, but axially adjustable manner.

The adjustment element can be brought with little effort into the desired adjustment position if the sliding guide has at least one guide projection, preferably at least two guide projections, which runs/run on the run-on bevel.

In a preferred exemplary embodiment according to the invention, the or a guide projection running on the run-on bevel is connected in a rotationally fixed manner, in particular rigidly, to the adjustment element. This guide projection can be molded, for example integrally, onto the adjustment element.

In order to be able to convert a rotational movement on the actuating element into an axial adjustment movement of the adjustment element, it is advantageous if the adjustment element is coupled in an axially movable and/or rotationally fixed manner to the actuating element, in particular is guided axially on the actuating element.

The outlay on design and production can be substantially reduced if the sliding guide forms a single-sided guide.

Since a rotational movement on the actuating element can be converted with the aid of the sliding guide into an axial adjustment movement of the adjustment element, it can be advantageous if the adjustment element is pressed against the single-sided guide by an incident flow water pressure.

In a particularly simple exemplary embodiment according to the invention, the sliding guide is formed by a thread. The run-on bevel can be formed here by a thread lead of the thread.

To this end, in a preferred development according to the invention, the sliding guide is formed by a screw connection between the actuating element and the adjustment element.

In order additionally also to simplify the outlay on design and production, it can be advantageous if the actuating element is connected rigidly, in particular integrally, to the adjustment element.

In order to adjust the quantity of water flowing through per unit of time to an adjustable maximum value, in a development according to the invention the functional unit is a throughflow quantity regulator, and a regulating profile of the throughflow quantity regulator is formed on the adjustment element and interacts with an elastic regulating body for regulating the throughflow quantity.

It is advantageous if an opening cross section of the throughflow opening can be changed with the adjustment element.

According to another exemplary embodiment according to the invention, it is provided that the functional unit is a flow restrictor, wherein the adjustment element adjusts an opening cross section of the flow restrictor.

The outflow-side partial region of the insert unit according to the invention that protrudes, for example, over an outlet mouthpiece can also serve as the actuating element if the actuating element forms a gripping surface on an outer circumference of the insert part.

In order to form a homogeneous and also non-sputtering outlet jet in the insert unit according to the invention, it is advantageous if the actuating element forms a sieve- or mesh-shaped outlet structure, in particular radially within the or a gripping surface.

In a particularly compact and functional design according to the invention, the actuating element has a lattice-, mesh- or honeycomb-cell-shaped outlet structure with a plurality of throughflow openings, which outlet structure participates in a rotational movement of the actuating element. In this exemplary embodiment, the actuating element has an outlet structure which is designed to be lattice-, mesh- or honeycomb-cell-shaped and has a plurality of throughflow openings. In said throughflow openings of the outlet structure, the water flowing through is formed into a homogeneous and non-sputtering water jet. The outlet structure is connected here to the actuating element and is preferably molded integrally thereon in such a manner that said outlet structure participates in a rotational movement of the actuating element.

An unintentional adjustment of the insert unit according to the invention is avoided if the or a guide track has plateau sections in which a rotation of the actuating element does not bring about an axial adjustment of the adjustment element.

For the same reason, it may be advantageous if the or a guide track has at least one latching depression for at least one or the at least one guide projection, which latching depression together with the at least one guide projection produces a latching resistance acting against rotation of the adjustment element.

### BRIEF DESCRIPTION OF THE DRAWINGS

Developments according to the invention emerge from the claims in conjunction with the description and the drawings. The invention will be described in more detail below with reference to preferred exemplary embodiments.

In the drawings:

FIG. 1 shows a sanitary insert unit which is shown in a partially cut-open perspective illustration and has a functional unit which is designed as an adjustable flow restrictor,

FIG. 2 shows the insert unit from FIG. 1 which can be mounted on the water outlet of a sanitary outlet fitting, in a perspective top view of its outlet end side,

FIG. 3 shows an insert unit which is likewise shown in a longitudinally sectioned perspective illustration and has a functional unit designed as a flow restrictor, wherein said functional unit can be adjusted by rotating two housing parts which are rotatable relative to each other,

FIG. 4 shows a diffusor which is provided in the housing interior of the insert unit shown in FIG. 3 and has to split the inflowing water into a multiplicity of individual jets before said individual jets can subsequently be thoroughly mixed in the housing interior with ambient air,

FIG. 5 shows the diffuser from FIG. 4 looking at its inflow-side end surface, wherein the diffusor has a central adjustment element opening which is bounded by the guide track of a sliding guide,

FIG. 6 shows the insert unit from FIG. 3 in a longitudinal section,

FIG. 7 shows the insert unit from FIGS. 3 and 6 in a cross section through the sectional plane VII-VII shown in FIG. 6,

FIG. 8 shows an outflow-side housing part of the housing of the insert unit shown in FIGS. 3, 6 and 7, in an illustration pulled apart from the adjustment element,

FIG. 9 shows the outflow-side housing part with the adjustment element in a perspective illustration rotated in relation to FIG. 8,

FIG. 10 shows the insert unit from FIGS. 3 and 6 in an exploded illustration of its components,

FIG. 11 shows an insert unit which is likewise shown here in a cut-open perspective illustration, which insert unit has a functional unit designed as a flow restrictor, wherein said functional unit has a throughflow opening, the clear opening cross section of which can be changed by means of an adjustment element, which is illustrated separately in FIG. 11,

FIG. 12 shows the adjustment element of the functional unit shown in FIG. 11, in a top view of the inflow side,

FIG. 13 shows the adjustment element from FIG. 12 in a longitudinal section through the sectional plane XIII-XIII in FIG. 14,

FIG. 14 shows the adjustment element from FIGS. 12 and 13 in a side view,

FIG. 15 shows the adjustment element from FIGS. 12 to 14 in a side view rotated by 90° in relation to FIG. 14,

FIG. 16 shows a partially longitudinally sectioned insert unit, the functional unit of which, which has an adjustment element illustrated separately here, is designed as a throughflow quantity regulator,

FIG. 17 shows the insert unit from FIG. 16 which is mounted on the water outlet of a sanitary outlet fitting with the aid of an outlet mouthpiece, looking through the water outlet, illustrated partially cut open, of the sanitary outlet fitting,

FIG. 18 shows the insert unit from FIGS. 16 and 17 mounted on the water outlet of the sanitary outlet fitting, wherein the insert unit itself is also illustrated here in partially longitudinally sectioned form,

FIG. 19 shows the insert unit from FIGS. 16 to 18 in a longitudinal section which is expanded in relation to FIG. 18,

FIG. 20 shows the insert unit from FIGS. 16 to 19 in a longitudinal section,

FIG. 21 shows the insert unit from FIGS. 16 to 20 in a cross section through the sectional plane XXI-XXI according to FIG. 20,

FIG. 22 shows the insert unit from FIGS. 16 to 21 which is likewise longitudinally sectioned here, in an adjustment position of its adjustment element, which position is changed in relation to FIG. 20,

FIG. 23 shows the insert unit from FIGS. 16 to 22 in a cross section through the sectional plane XXIII-XXIII according to FIG. 22,

FIG. 24 shows a partially longitudinally sectioned insert unit, the functional unit of which, which is designed as an adjustable flow restrictor, has an adjustment element, which adjustment element is guided in the insert unit in a rotationally fixed, but axially displaceable manner, wherein a rotational movement on an actuating element can be converted with the aid of a thread serving as a sliding guide into an axial adjustment movement of the adjustment element,

FIG. 25 shows the insert unit from FIG. 24 which is longitudinally sectioned here, in an open position of the functional unit designed as an adjustable flow restrictor,

FIG. 26 shows the longitudinally sectioned insert unit from FIGS. 24 and 25 in a flow restrictor position which is reduced by contrast in the clear throughflow cross section,

FIG. 27 shows an insert unit which is illustrated in partially longitudinally sectioned form and has a functional unit which has an adjustment element guided in the insert unit in a rotationally fixed, but axially displaceable manner, which adjustment element has, on its outflow side, at least one axially protruding sliding web which slides on the guide track of a sliding guide molded onto the actuating element on the circumferential side,

FIG. 28 shows the insert unit from FIG. 27 in a detailed longitudinal section in the region of the sliding guide provided between the actuating element and the adjustment element,

FIG. 29 shows the insert unit from FIGS. 27 and 28 in a cross section,

FIG. 30 shows the insert unit from FIGS. 27 to 29 in a longitudinal section through the sectional plane XXX-XXX according to FIG. 29,

FIG. 31 shows the outflow-side housing part, serving as actuating element, of the insert unit shown in FIGS. 27 to 30, together with the adjustment element, in an exploded and partially longitudinally sectioned illustration of the individual parts, and

FIG. 32 shows an alternative design of the actuating element and adjustment element in comparison with FIG. 31.

### DETAILED DESCRIPTION

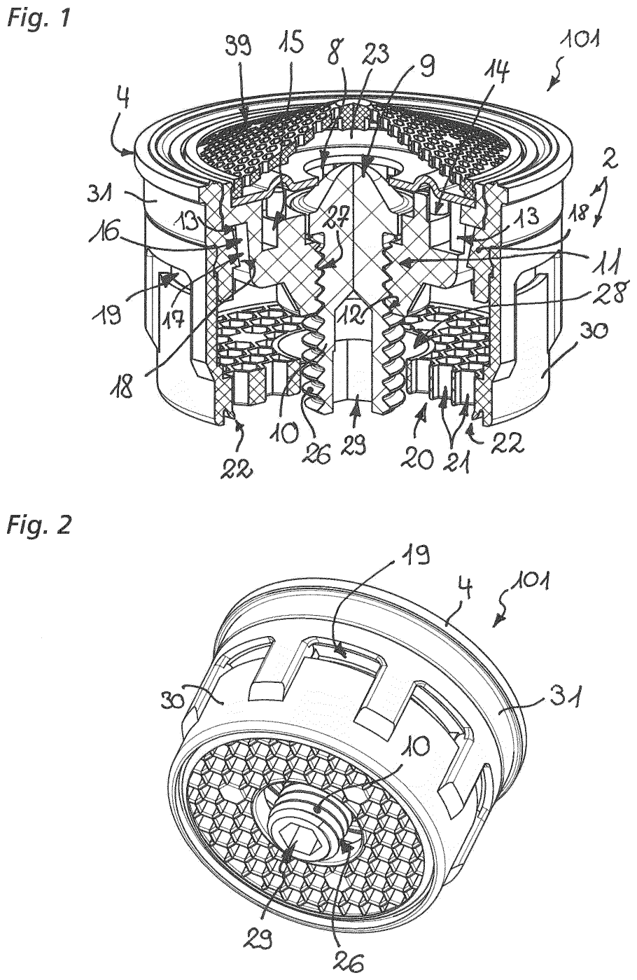

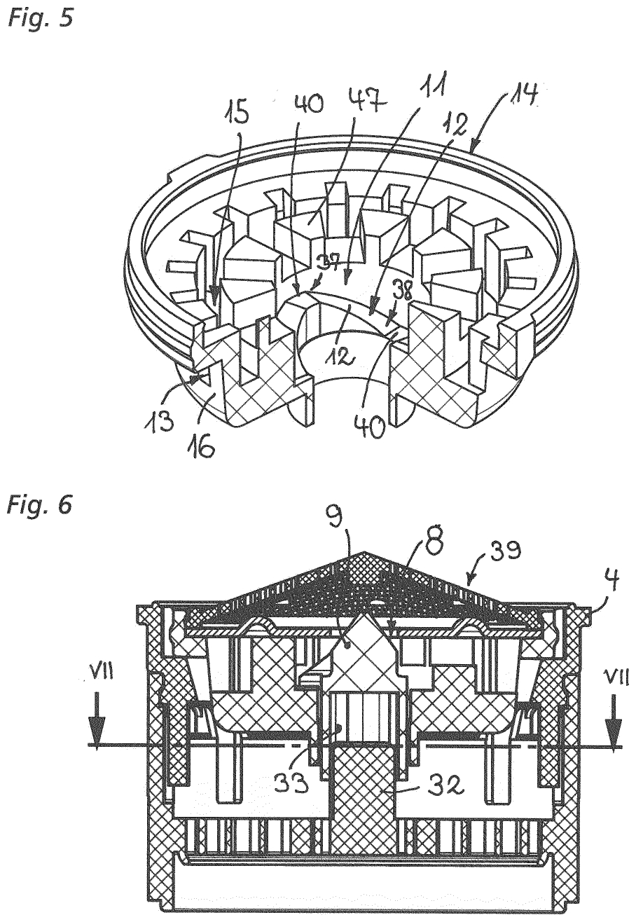

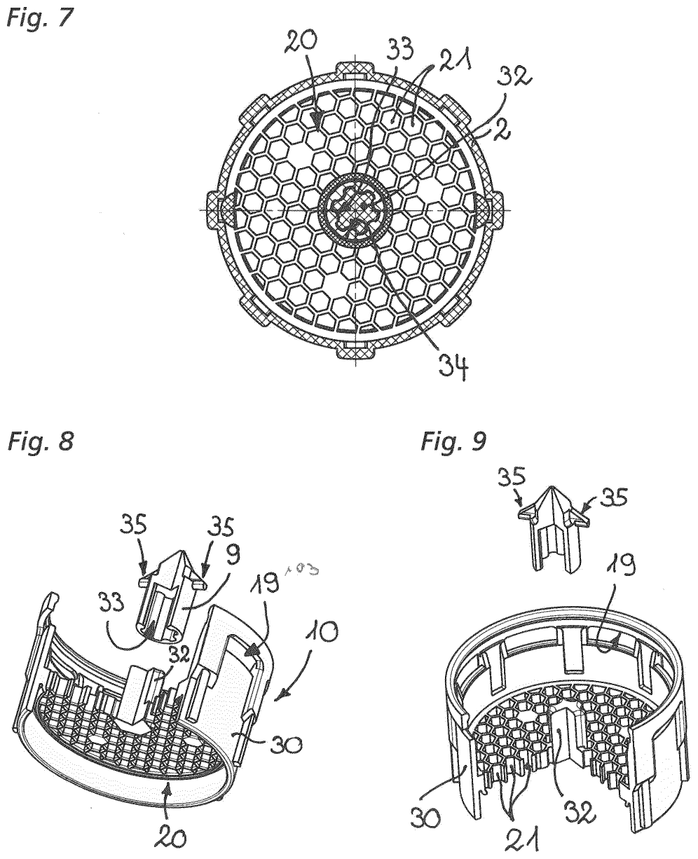

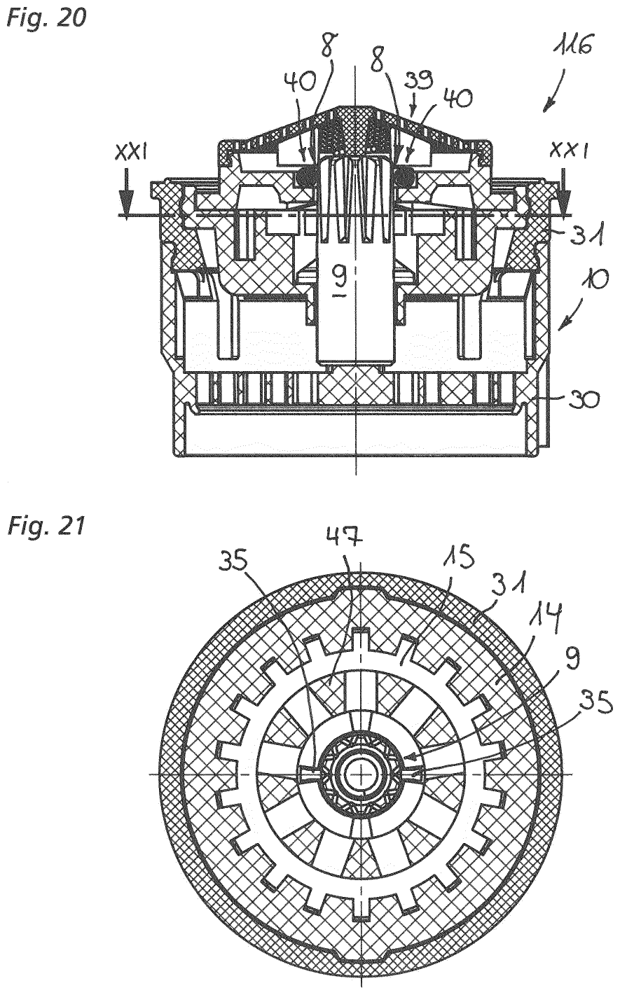

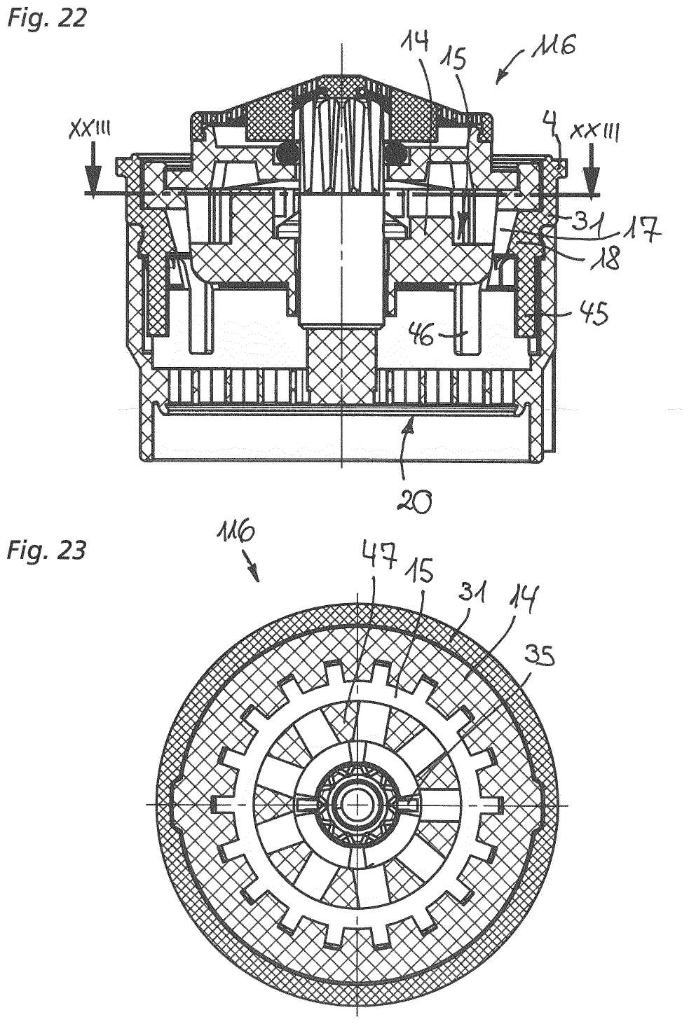

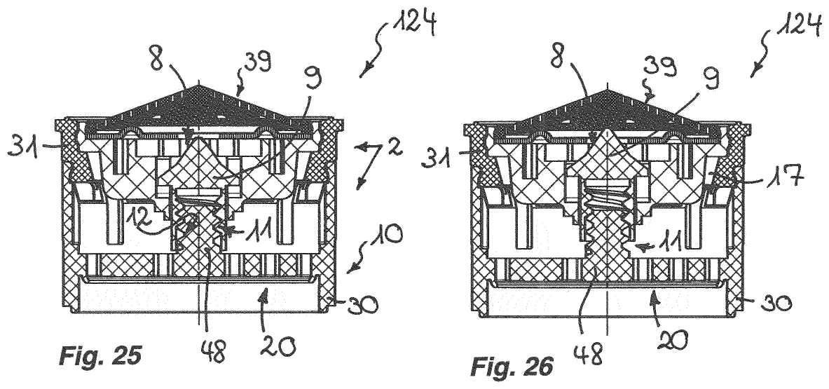

FIGS. 1 to 31 show a sanitary insert unit in the embodiments 101, 103, 111, 116, 124 and 127. The sanitary insert unit 101, 103, 111, 116, 124 and 127 can be inserted into the water outlet 1 of a sanitary outlet fitting. The exemplary embodiments 101, 103, 111, 116, 124 and 127 shown here have a single- or multi-part housing 2 which can be inserted into a sleeve-shaped outlet mouthpiece 3 which outlet mouthpiece 3 can be mounted releasably, and in particular can be screwed releasably, on the water outlet 1 of the outlet fitting. An annular step or annular flange 4 is provided here on the housing outer circumference of the housing 2, said annular step or annular flange resting on the inner circumference of the sleeve-shaped outlet mouthpiece 3 in the use position of the insert units 101, 103, 111, 116, 124 and 127 (cf. FIG. 19).

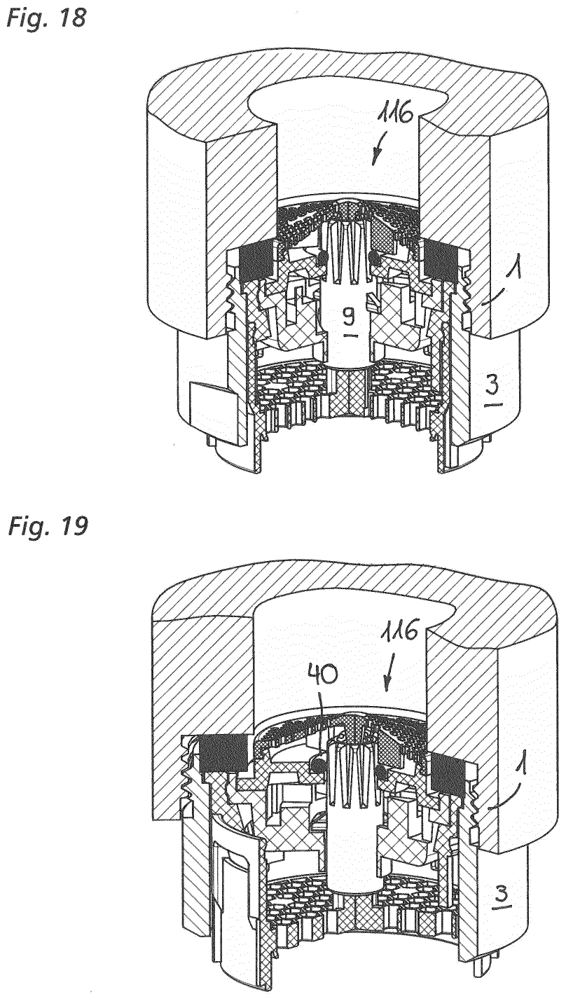

FIGS. 18 and 19 show with reference to the exemplary embodiment 116 by way of example that the sleeve-shaped outlet mouthpiece 3 can be provided with a thread 5 which can be screwed to a mating thread 6 at the outlet-side end of a fitting body of the sanitary outlet fitting. The outer circumference of the outlet mouthpiece 3 here is provided with at least one tool engagement surface 7, on which a rotary tool and in particular a spanner used as a rotary tool can be fitted.

A functional unit is provided in the housing interior of the housing 2 of the insert units 101, 103, 111, 116, 124 and 127, said functional unit being able to be designed as a flow restrictor limiting the throughflow (cf. insert units 101, 103, 111, 124, 127) or else as a throughflow quantity regulator adjusting the volume of water flowing through per unit of time independently of the pressure to a maximum value (cf. insert unit 116). The functional units provided in the insert units 101, 103, 111, 116, 124 and 127 provide a throughflow opening 8, which is configured as an annular gap or regulating gap, for this purpose in the housing interior of the housing 2. An adjustment element 9 on the outflow side of the throughflow opening 8 is actuable in such a manner here that said adjustment element 9 can be adjusted axially into the throughflow opening 8, to increase a flow resistance formed by the throughflow opening 8, and out of the throughflow opening 8, to reduce said flow resistance.

The adjustment element 9 is in driving connection with an actuating element 10, which actuating element 10 is arranged on the outflow side of the throughflow opening 8 and is actuable from the outside. A sliding guide 11 having at least one run-on bevel 12 is arranged in the driving connection between the actuating element 10 and the adjustment element 9, said sliding guide converting a rotational movement on the actuating element 10 into an axial adjustment movement of the adjustment element 9.

With the aid of the insert units 101, 103, 111, 116, 124 and 127 illustrated here, not only is the throughflowing quantity of water intended to be restricted (insert units 101, 103, 111, 124 and 127) or adjusted independently of the pressure to a maximum value of the throughflow capacity (cf. insert unit 116)—what is more common the water flowing out in the insert units 101, 103, 111, 116, 124 and 127 is intended also to be formed into a homogenous, non-sputtering and optionally also sparkling-soft outlet jet.

For this purpose, the insert units 101, 103, 111, 116, 124 and 127 have a jet splitter which is arranged on the outflow side of the throughflow opening 8 and splits the water flowing through into a multiplicity of individual jets.

For this purpose, said jet splitter has a corresponding number of throughflow holes 13 in which an individual jet is in each case formed. The jet splitter could be designed as a perforated plate arranged approximately transversely with respect to the throughflow direction. By contrast, in the case of the insert units 101, 103, 111, 116, 124 and 127, the jet splitter is designed as a diffusor 14 which has a deflection surface 15 which deflects the water flowing through the housing 2 approximately radially outward and is bounded by an annular wall 16 which is raised in comparison thereto counter to the throughflow direction. The throughflow holes 13 of said jet splitter that are preferably spaced apart uniformly from one another in the circumferential direction are provided in the annular wall 16.

The throughflow holes 13 open in an annular gap 17 which narrows in the throughflow direction and is formed between the diffusor 14, serving as the jet splitter, and in particular the annular wall 16 thereof, on the one hand, and a diffusor ring 18 engaging around the diffusor 14, on the other hand. This diffusor ring 18 can be designed as a separate insert part which can be inserted into the housing 2, and is molded integrally here by contrast onto the housing inner circumference of the housing 2.

Since the annular gap 17 formed between diffusor 14 and diffusor ring 18 narrows at least in regions in the throughflow direction and since the water flowing therethrough undergoes an increase in speed in regions, a negative pressure arises on the outflow side of said annular gap in accordance with Bernoulli's equation, by which negative pressure ambient air can be sucked into the housing interior of the housing 2. So that said ambient air can flow into the housing 2, the housing 2 has one and preferably a plurality of ventilation openings 19 in the throughflow direction of the water preferably directly below the annular gap 17 and in particular below the diffusor ring 18, which ventilation openings 19 are designed as housing apertures, which are in particular spaced apart uniformly from one another in the circumferential direction, in the circumferential wall of the housing 2. The sucked-up ambient air is mixed in the housing interior with the water flowing therethrough before the water which is swelled in such a manner and mixed thoroughly in the ambient air is formed into a sparkling-soft overall jet in a flow rectifier 20 provided on the outflow side.

The flow rectifier 20 can be a lattice structure or mesh structure consisting of webs crossing one another at intersections, which webs restrict throughflow openings 21 between them. The flow rectifier 20 can be formed from a plurality of such lattice or mesh structures arranged at a small distance from one another. In the case of the insert units 101, 103, 111, 116, 124 and 127 illustrated here, the flow rectifier 20 is formed by only one such lattice structure which here has honeycomb-cell-shaped throughflow openings 21. This lattice structure is molded integrally onto the housing 2 and here forms the outlet end side thereof. An encircling cross-section-narrowing housing constriction 22 is provided preferably directly below the flow rectifier 20, said housing constriction contributing to the homogenization of the emerging water and counteracting spraying of the emerging water jet.

The insert units 101, 103, 111, 124 and 127 shown in FIGS. 1 and 2, 3 to 10 and 11 to 15, 24 to 26 and 27 to 31 have a functional unit which is designed as a flow restrictor and in which the opening cross section of the throughflow opening 8 can be changed with the adjustment element 9. While the adjustment element 9 of the insert units 101, 103, 124 and 127 is expanded in the throughflow direction at its inflow-side end and is designed here approximately in the shape of a cone or arrow tip, the inflow-side end region of the adjustment element 9 provided in the insert unit 111 has a substantially cylindrical outer contour in which hollows which are open toward the cylinder circumference and toward the inflow side and tapering in the throughflow direction are formed, the hollows being distributed at preferably uniform distances over the circumference of the adjustment element 9.

The adjustment elements 9 of the insert units 101, 103, 111, 116, 124 and 127 interact with a plate 23 which is connected upstream of the adjustment elements 9 on the inflow side and in which a preferably central adjustment element opening 24 is provided. In the case of the insert units 101, 103, 124 and 127, the annular throughflow opening 8 is formed between the circumferential edge of the plate 23 bounding the adjustment element opening 24, and the adjustment element 9, the clear opening cross section of said annular throughflow opening being able to be increased or reduced by axial adjustment of the adjustment element 9. In the case of the insert unit 111, depending on the axial relative position of the adjustable adjustment element 9, the circumferential edge of the plate 23 bounding the adjustment element opening 24 interacts with differently sized cross sections of the throughflow grooves 25 provided in the adjustment element 9, and therefore, depending on the axial relative position of the adjustment element 9, the opening cross section of the throughflow opening 8 bounded by the throughflow grooves 25 can also be reduced or increased here to a greater or lesser extent.

In the case of the insert unit 101, the sliding guide provided between the actuating element 10 and the adjustment element 9 is formed by an external thread 26 arranged on the outer circumference of the actuating element 10 and by a complementing mating thread 27 which is formed in a threaded opening arranged centrally in the diffusor 14. The thread leads here form a run-on bevel which converts a rotational movement of the actuating element into an axial adjustment of the adjustment element 9 which is preferably connected integrally here to the actuating element 10. At its end region facing away from the adjustment element 9, the actuating element 10 protrudes into a central actuating element opening 28 in the outlet-side lattice structure. The end surface of the actuating element 10 is provided with a tool engagement surface 29 which is designed here as a hexagon socket and on which a rotary tool (not shown specifically) can be fitted.

The housings 2 of the insert units 101, 103, 111, 116, 124 and 127 have at least two housing parts 30, 31 which are connectable releasably to one another and are preferably latchable to one another. As is shown by way of example in FIGS. 18 and 19, the outflow-side housing part 30 protrudes at least with its outflow-side partial region over the outlet mouthpiece 3 such that the actuating element 10 is formed here by the housing outer circumference which serves as a gripping surface.

A noncircular coupling pin 32 which here is approximately star-shaped in cross section is molded on the inflow side onto the outlet-side lattice structure of the insert units 103, 111 and 116, the lattice structure serving as the flow rectifier 20, the coupling pin protruding into a shape-adapted coupling opening 33 on the adjacent end of the adjustment element 9. The actuating element 10 and the adjustment element 9 are arranged in a rotationally fixed, but axially adjustment manner with respect to each other via the coupling pin 32 and the coupling opening 33. A rotational movement on the actuating element 10 is therefore transmitted to the adjustment element 9 via the coupling pin 32 and the coupling opening 33.

In the case of the insert units 103, 111, 116, 124 and 127, a rotary force exerted on the housing outer circumference of the housing part 30, said housing outer circumference serving as a gripping surface, is transmitted to the adjustment element 9. So that the outflow-side housing part 30 serving as the actuating element 10 can be rotated relative to the inflow-side housing part 31, the annular flange 4—as can be seen in FIGS. 18 and 19—is clamped between the annular step on the inner circumference of the sleeve-shaped outlet mouthpiece 3 and the opposite end surface of the water outlet 1. While the inflow-side housing part 31 which is clamped in a rotationally fixed manner cannot be rotated further, the outflow-side housing part 30 is, by contrast, held rotatably on the housing part 31.

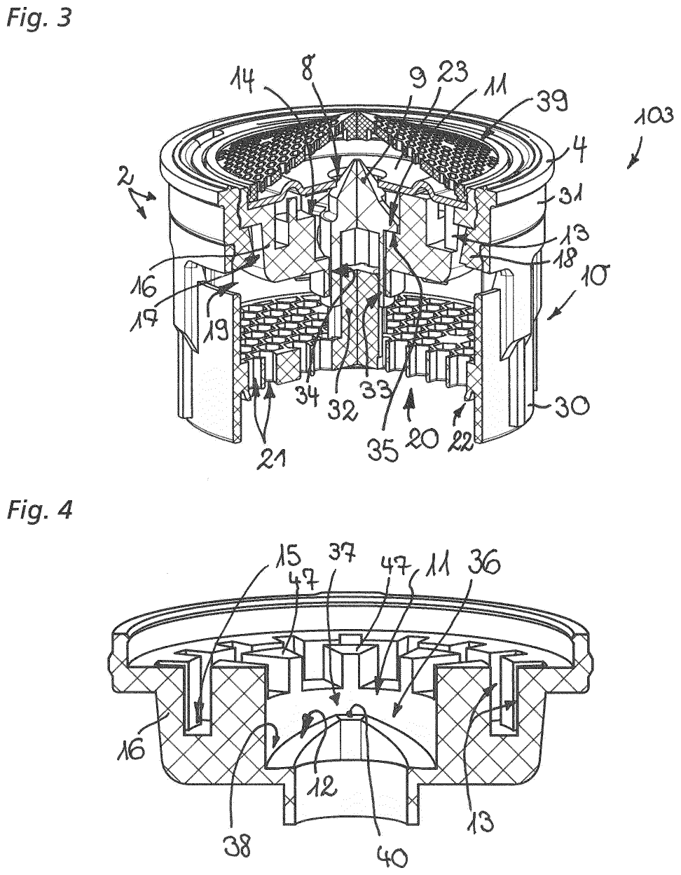

It becomes clear from FIGS. 3, 6, 11, 16, 18 to 20, 22, 24 to 26, 27 and 30, that the adjustment element 9 of the functional units 103, 111, 116, 124 and 127 passes through a preferably central reach-through opening 34 in the diffusor 14. The adjustment element 9 rests here with a cross-sectionally expanded partial region or with at least one guide projection 35 and preferably two guide projections 35 protruding on opposite sides of the adjustment element 9 on a sliding guide which is designed as a closed guide track 36 and is formed on the inflow side of the edge region of the diffusor 14 bounding the reach-through opening 34. Said closed guide track 36 has at least one elevation 37 and at least one hollow 38, which elevations 37 and hollows 38 are connected to one another via run-on bevels 12. The sliding guide 11 defines a closed guide track 36, and therefore the adjustment element 9 returns into its starting position at the latest after a full revolution, but in particular after a half revolution. A rotational movement of the adjustment element 9 is converted by the guide projections 35 sliding on the guide track 36 into an axial adjustment movement of the adjustment element 9.

The sliding guide is designed here as a single-sided guide, in which the adjustment element 9 is pressed, in particular with its guide projections 35, onto the guide track 36. The incident flow water pressure in the case of the insert units 101, 103 and 111 presses the adjustment element 9 here against the single-sided guide of the guide track 36. By contrast, the adjustment element 9 of the insert unit 116 is pressed by a compression spring 37 against the guide of the guide track 36, which compression spring 37 is arranged in an insert opening 57 in the adjustment element 9 and is supported on one side on the adjustment element 9 and on the other side on an inflow-side sieve attachment 39.

The insert units 101, 103, 111, 116, 124 and 127 have such an inflow-side sieve attachment 39 which has to filter out the lime particles and other dirt particles carried along in the water before said dirt particles in the housing interior can adversely affect the function of the insert units 101, 103, 111, 116, 124 and 127. The guide track 36 has plateau sections 40 in which rotation of the actuating element 10 does not bring about an axial adjustment of the adjustment element 9. The hollows 38 in the guide track 36 are designed as a latching depression for the guide projections 35, which latching depression together with the guide projections 35 produces a latching resistance acting against rotation of the adjustment element 9.

The functional unit provided in the insert unit 116 is designed as a throughflow quantity regulator which is intended to adjust the water volume flowing through per unit of time independently of the pressure to an adjustable maximum value. For this purpose, the adjustment element 9 of the insert unit 116 has a regulating profile which has hollows which are open toward the inflow side and toward the adjustment element circumference and which have a clear hollow cross section which is increasingly reduced in the throughflow direction. The regulating profile provided on the adjustment element 9 of the insert unit 116 interacts with an annular regulating body 40 of elastic material which, depending on the pressure of the inflowing water, is molded to a greater or lesser extent into the hollows of the regulating profile arranged on the adjustment element 9 and therefore changes the throughflow opening 8 between the adjacent edge region of plate and the regulating body 40 on the one hand and the adjustment element 9 on the other hand.

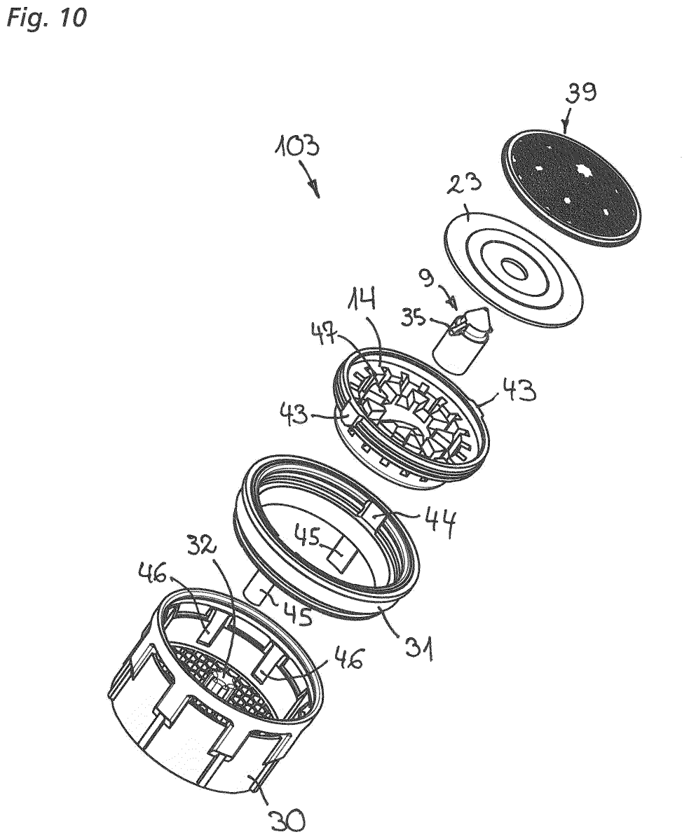

It can be seen in FIG. 10 that the insert unit 103 has, on the outer circumference of its diffusor 14, at least one anti-rotation projection 43 which engages in an anti-rotation cutout 44 on the inner circumference of the diffusor ring 18. Since the diffusor ring 18 which is molded onto the inflow-side housing part 31 is held in a rotationally fixed manner on the water outlet 1 of the sanitary outlet fitting, the diffusor 14 is also secured in a rotationally fixed manner if the outflow-side housing part 30 is rotated relative thereto.

It can be seen in FIG. 10 that at least one snap tab 45 can be molded onto the inflow-side housing part 31 and in particular onto the diffusor ring 18, which is molded integrally thereon, the snap tab interacting with at least one snap formation 46 on the inner circumference of the outflow-side housing part with the effect of a latching mechanism. The at least one snap tab 45 interacting with the snap formations 46 imparts a latching sensation to the user here when the user rotates the outflow-side housing part. In order to increase and/or to refine the latching sensation, a ball catch is provided at the free tab end region of the snap tab 45, the ball catch interacting with a spherical recess in the snap formation 46. However, for the same purpose, it is also possible to provide small depressions in the guide track 36 and in particular in the region of its elevations 37 and/or hollows 38, in order likewise to impart a latching-in sensation upon rotating the lower housing part.

Since the throughflow opening forms a cross-sectional narrowing and leads to an increase in speed of the water flowing through, in order to reduce the flow speed in the region of the diffusor 14 it is provided that flow obstacles 47 connected upstream of the throughflow holes 13 are arranged in the region of the deflecting surface 15 of said diffusor.

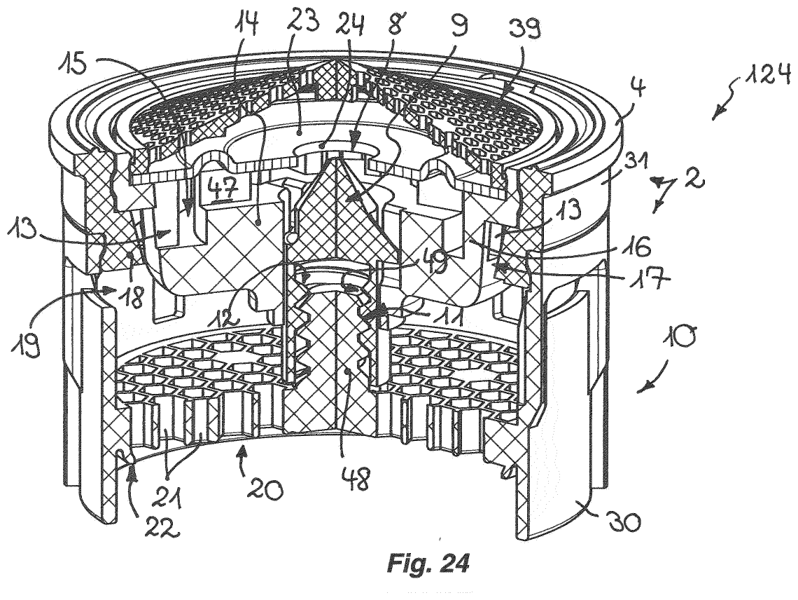

Also in the case of the insert units 124, 127 shown in FIGS. 24 to 26 and 27 to 31, the inflow-side housing part 31 is held with its annular flange 4 on the water outlet of a sanitary outlet fitting in a rotationally fixed manner, while, by contrast, the outflow-side housing part 30 serves as an actuating element 10 which can be gripped manually on the outer housing circumference. As in the case of the insert units 103, 111 and 116, the outflow-side housing part 30 serving as actuating element 10 has an outlet structure which forms the outlet end side of said insert units and has a plurality of throughflow openings 21 which are honeycomb-cell-shaped here, which outlet structure participates in a rotational movement on said actuating element 10.

The insert unit 124 has an actuating element 10, on the outlet structure of which, which is designed as a flow rectifier, a threaded pin 48 protrudes on the inflow side counter to the throughflow direction. Said threaded pin 48 has an external thread which serves as a sliding guide for the adjustment element 9. For this purpose, the adjustment element 9 has a threaded opening 49 with an internal thread, into which internal threads the external thread of the threaded pin 48 is screwed. At least one guide projection 50 protrudes laterally on the adjustment element 9, said guide projection being guided in an axially displaceable manner in an associated axial guide groove 51, which guide groove 51 is provided in the diffusor 14 and is open toward the reach-through opening 34 in the diffusor 14.

A rotational movement on the actuating element 10 is therefore transmitted to the threaded pin 48. Since the adjustment element 9 of the insert unit 124 is guided in the reach-through opening 34 of the diffusor 14 in a rotationally fixed, but axially displaceable manner, the rotational movement transmitted to the threaded pin 48 and its external thread serving as sliding guide is converted into an axial adjustment movement of the adjustment element 9.

In a modified design (not shown here) of the insert unit 124, the threaded pin 48 can instead also have an internal thread, into which the adjustment element 9 is screwed by means of an external thread.

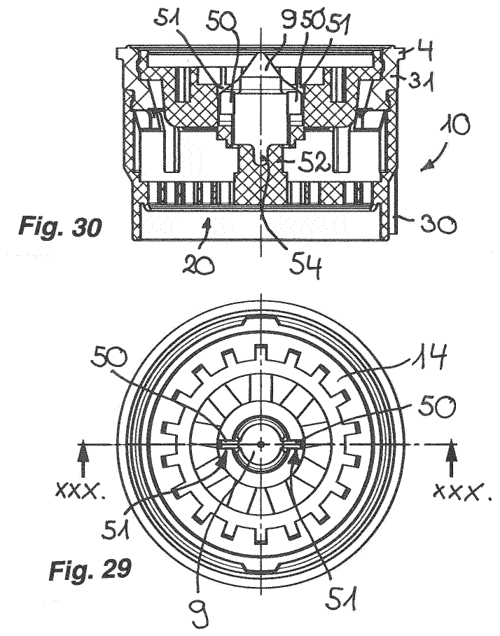

In the case of the insert units 124 and 127, the adjustment element 9 is guided in the reach-through opening 34 of the diffusor 14 in a rotationally fixed, but axially displaceable manner. A guide pin 52 protrudes here on the outlet structure of the insert unit 127, with a sliding guide 11 configured as a slotted guide track being molded onto the circumference of said guide pin. The guide pin 52 protrudes with its free pin end into a guide opening 53 which is provided on the end side of the adjustment element 9, said end side facing the outlet structure. The adjustment element 9 of the insert unit 127 has at least one sliding web 54 and—as here—preferably two sliding webs 54 arranged on opposite sides of the adjustment element 9, which sliding webs 54 slide on the guide track of the encircling sliding guide 11 and leave the run-on bevels 12, which are provided in sections on the guide track, are spaced apart from one another and are arranged at different heights of the guide pin 53, during a rotational movement on the actuating element 10 in such a manner that the adjustment element 9 carries out a corresponding adjustment movement in the axial direction. Small clips 55 are molded in here over the course of said guide track, into which dips the sliding web 54 can latch in such a manner that the adjustment position of the adjustment element 9 is secured. It can be seen in FIGS. 29 and 30 that the guide projections 50 which protrude laterally on the adjustment element 9 and which are each guided in a guide groove 51 guide the adjustment element 9 in the reach-through opening 34 of the diffusor 14 in a rotationally secured, but axially displaceable manner.

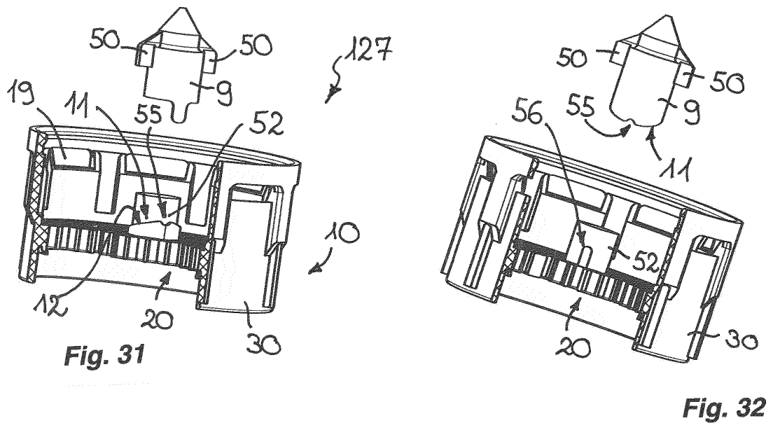

The sliding guide 11 formed in an encircling manner on the circumference of the guide pin 52 and having one of other clips 55 can readily be seen in FIG. 31. A design which is modified in comparison thereto and in which the guide track serving as sliding guide is formed by the end edge of the adjustment element 9 facing the outlet structure while, by contrast, a sliding web 56 is molded onto the circumference of the guide pin 52 is illustrated in FIG. 32. In this case, dips 55 can also be provided in the guide track of the sliding guide provided on the end edge of the adjustment element 9, said clips interacting as latching notches with the sliding web 56.

The insert units 101, 103, 111, 116, 124 and 127 illustrated here form a jet ventilator which forms the emerging water into a homogenous, non-sputtering and sparkling-soft water jet. A flow restrictor (insert units 101, 103, 111, 124, 127) or a throughflow quantity regulator (insert unit 116) is integrated in said jet ventilators, said flow restrictor or throughflow quantity regulator restricting the water volume flowing through or adjusting same independently of the pressure to an adjustable maximum value. The insert units 101, 103, 111, 116, 124 and 127 described here are distinguished here by high functional reliability, cost-effective production capability and high operating comfort.

### LIST OF REFERENCE SIGNS

1 Water outlet

2 Housing

3 Outlet mouthpiece

4 Annular flange

5 Thread

6 Mating thread

7 Tool engagement surface

8 Throughflow opening

9 Adjustment element

10 Actuating element

11 Sliding guide

12 Run-on bevel

13 Throughflow holes

14 Diffusor

15 Deflecting surface

16 Annular wall

17 Annular gap

18 Diffusor ring

19 Ventilation opening

20 Flow rectifier

21 Throughflow openings

22 Housing constriction

23 Plate

24 Adjustment element opening

25 Throughflow groove

26 External thread

27 Mating thread

28 Actuating element opening

29 Tool engagement surface

30 Outflow-side housing part

31 Inflow-side housing part

32 Coupling pin

33 Coupling opening

34 Reach-through opening

35 Guide projection

36 Guide track

37 Compression spring

38 Hollow

39 Sieve attachment

40 Plateau section

41 Regulating body

43 Anti-rotation projection

44 Anti-rotation cutout

45 Snap tab

46 Snap formation

47 Flow obstacles

48 Threaded pin

49 Threaded opening

50 Guide projection

51 Guide groove

52 Guide pin

53 Guide opening

54 Sliding web

55 Dip

56 Sliding web

57 Insert opening

101 Insert unit (according to FIGS. 1 and 2)

103 Insert unit (according to FIGS. 3 to 10)

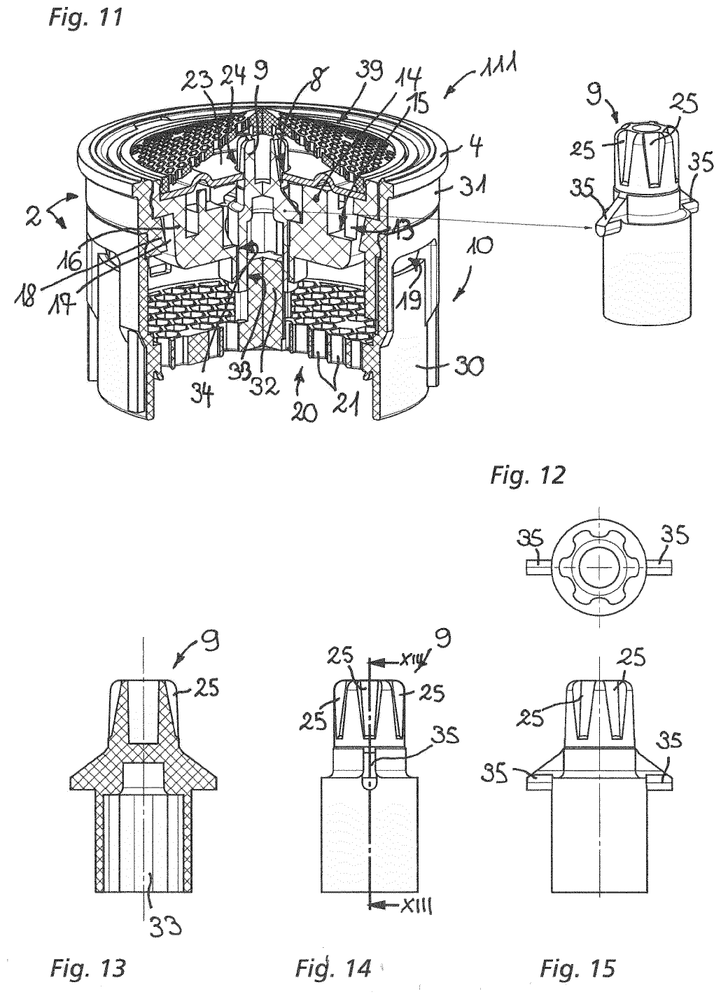

111 Insert unit (according to FIGS. 11 to 15)

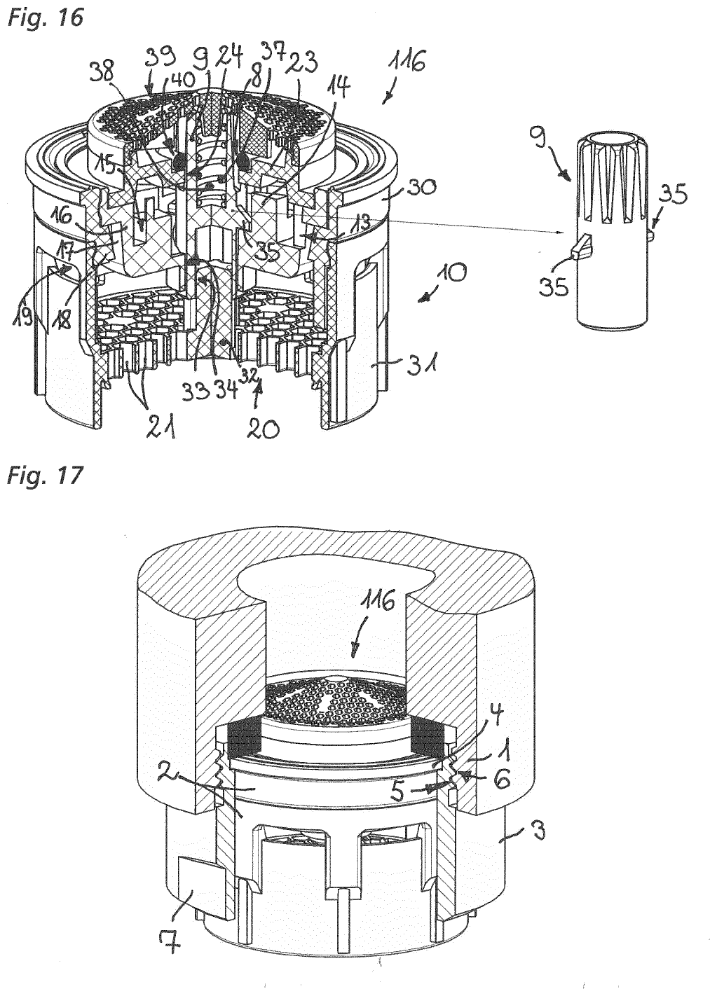

116 Insert unit (according to FIGS. 16 to 23)

124 Insert unit (according to FIGS. 24 to 26)

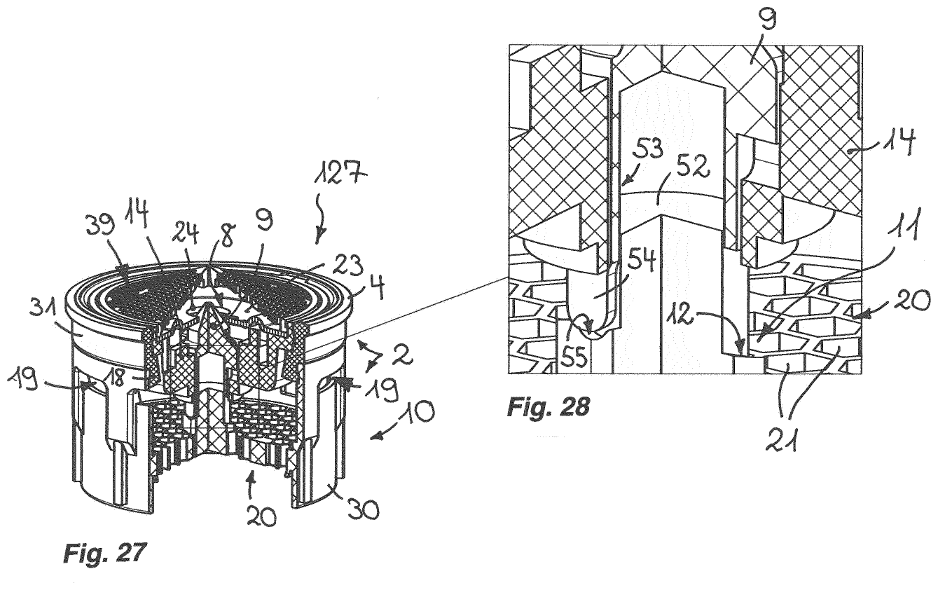

127 Insert unit (according to FIGS. 27 to 31)

1. A sanitary insert unit (101, 103, 111, 116, 124, 127) comprising:
a functional unit which provides a throughflow opening (8) and has an adjustment element (9), said adjustment element (9) is arranged so as to be movable or adjustable axially into the throughflow opening (8) and out of the throughflow opening (8),
an actuating element (10) arranged on the outflow side of the throughflow opening (8), the adjustment element (9) being in driving connection with said actuating element (10) which is actuable from the outside,
a sliding guide (11) having at least one run-on bevel (12) that acts on at least one of the actuating element (10) or the adjustment element (9) to convert a rotational movement of the actuating element (10) into an axial adjustment movement of the adjustment element (9).

2. The sanitary insert unit as claimed in claim 1, wherein the sliding guide (11) defines a closed guide track (36) by which the adjustment element (9) returns into a starting position at latest after a full revolution of the actuating element (10).

3. The sanitary insert unit as claimed in claim 1, wherein the sliding guide (11) is stop-free.

4. The sanitary insert unit as claimed in claim 1, wherein the sliding guide (11) is step-free or jump-free.

5. The sanitary insert unit as claimed in claim 1, wherein a gradient of the run-on bevel (12) is dimensioned such that the sliding guide (11) is self-locking.

6. The sanitary insert unit as claimed in claim 1, wherein the run-on bevel (12) forms a section of a guide track (36).

7. The sanitary insert unit as claimed in claim 1, further comprising a latching mechanism, is formed, with which at least one of the actuating element (10) or the adjustment element (9) is fixable in different angular positions.

8. The sanitary insert unit as claimed in claim 7, wherein the latching mechanism is formed on the sliding guide (11).

9. The sanitary insert unit as claimed in claim 1, wherein the run-on bevel (12) is formed on a housing part or an insert part.

10. The sanitary insert unit as claimed in claim 1, wherein the adjustment element (9) is mounted rotatably and in an axially rotationally displaceable manner on a housing part or an insert part.

11. The sanitary insert unit as claimed in claim 1, wherein the adjustment element (9) is guided in a rotationally fixed, but axially displaceable manner on a housing part or an insert part.

12. The sanitary insert unit as claimed in claim 1, wherein the adjustment element (9) is in driving connection with the actuating element (10) in a rotationally fixed, but axially adjustable manner.

13. The sanitary insert unit as claimed in claim 1, further comprising at least one guide projection (35) which runs on the run-on bevel (12).

14. The sanitary insert unit as claimed in claim 13, wherein the at least one guide projection (35) running on the run-on bevel (12) is connected in a rotationally fixed manner to the adjustment element (9).

15. The sanitary insert unit as claimed in claim 1, wherein the adjustment element (9) is coupled in at least one of an axially movable or rotationally fixed manner to the actuating element (10).

16. The sanitary insert unit as claimed in claim 1, wherein the sliding guide (11) forms a single-sided guide.

17. The sanitary insert unit as claimed in claim 16, wherein the adjustment element (9) is configured to be pressed against the single-sided guide by at least one of an incident flow water pressure or at least one press-on element.

18. The sanitary insert unit as claimed in claim 17, wherein the at least one press-on element comprises a compression spring (37).

19. The sanitary insert unit as claimed in claim 1, wherein the sliding guide (11) is formed by a thread (5).

20. The sanitary insert unit as claimed in claim 1, wherein the sliding guide (11) is formed by a screw connection between the actuating element (10) and the adjustment element (9).

21. The sanitary insert unit as claimed in claim 1, wherein the actuating element (10) is connected rigidly to the adjustment element (9).

22. The sanitary insert unit as claimed in claim 1, wherein the functional unit is a throughflow quantity regulator, and a regulating profile of the throughflow quantity regulator is formed on the adjustment element (9) and interacts with an elastic regulating body (40) for regulating a throughflow quantity.

23. The sanitary insert unit as claimed in claim 1, wherein an opening cross section of the throughflow opening (8) is changeable with the adjustment element (9).

24. The sanitary insert unit as claimed in claim 1, wherein the functional unit is a flow restrictor, and the adjustment element (9) adjusts an opening cross section of the flow restrictor.

25. The sanitary insert unit as claimed in claim 1, wherein the actuating element (10) comprises a gripping surface on an outer circumference of the insert unit (103, 111, 116).

26. The sanitary insert unit as claimed in claim 1, wherein, the actuating element (10) comprises a sieve- or mesh outlet structure.

27. The sanitary insert unit as claimed in claim 1, wherein the run-on bevel (12) forms a section of a guide track (36) that includes plateau sections (40) in which a rotation of the actuating element (10) does not bring about an axial adjustment of the adjustment element (9).

28. The sanitary insert unit as claimed in claim 27, wherein the guide track (36) has at least one latching depression for receiving at least one guide projection (35) on the adjustment element (9), said latching depression together with the at least one guide projection (35) produce a latching resistance acting against rotation of the adjustment element (9).
